(19) United States
(12) Patent Application Publication
(10) Pub. No.: US 2019/0044418 A1
(43) Pub. Date: Feb. 7, 2019

(54) POSITION SENSOR AND MOTOR

(71) Applicant: MABUCHI MOTOR CO., LTD., Chiba (JP)

(72) Inventor: Akira MATSUNAWA, Chiba (JP)

(21) Appl. No.: 16/049,824

(22) Filed: Jul. 31, 2018

(30) Foreign Application Priority Data
Aug. 7, 2017 (JP) 2017-152398

(51) Int. Cl. H02K 11/225

(52) U.S. Cl. CPC H02K 11/225

(57) ABSTRACT

A position sensor includes a stator, a rotor, an excitation circuit, and a processing unit. The stator is tubular and disposed concentrically with the center of rotation of the shaft. The stator includes magnetic pole pairs having a pair of magnetic poles protruding from an inner peripheral surface toward the center of rotation and opposed to each other. The rotor is fixed to the shaft and includes at least a pair of protruding poles protruding radially outward from a reference cylindrical surface at a constant distance from the center of rotation. The excitation circuit includes coil pairs wound on the magnetic poles of the respective magnetic pole pairs and a switch for switching on/off of currents to the coil pairs. The processing unit causes the switch to switch during rotation of the rotor, and detects a rotor position based on the magnitude relationship of an inductance between the coil pairs.

### BACKGROUND

### 1. Technical Field

The present invention relates to an inductive position sensor for detecting a rotor rotational position of a motor, and to a motor equipped with the position sensor.

### 2. Description of the Related Art

Conventionally, motors (such as brushless motors, in particular) may be provided with a detector (sensor) for detecting the rotational speed or rotation angle (rotational position) of the motor. An example of the detector is a Hall sensor which detects the rotational position of the rotor, using the magnetic flux of a permanent magnet in the rotor of the motor (see Japanese Patent No. 2639521, for example). In a brushless motor equipped with a Hall sensor, the rotational position of the rotor is identified based on an output signal from the Hall sensor, and the rotor is rotated by causing current to flow at optimum timings.

### SUMMARY

However, in the case of a position detection means using a Hall sensor and a permanent magnet, weight balance adjustments and securing with respect to the rotating shaft must be made carefully. This is because the strength (robustness) of the magnet is low compared with metals such as iron, and it is difficult to increase the processing accuracy of the magnet. Accordingly, the position detection means which is configured to withstand high speed rotation may result in an increase in manufacturing cost. In addition, electronic components, such as a Hall sensor, are often not resistant to a high-temperature environment, and may not be usable under a high-temperature environment, such as around the engine of a vehicle.

Motors that do not use a permanent magnet (such as a switched reluctance motor, hereafter referred to as “SR motor”) have the advantage of high robustness and heat resistance due to the absence of a magnet. However, the advantage is lost if the SR motor is equipped with a position detection means in which a permanent magnet is used. Thus, the development of a sensor capable of detecting the rotational position of the rotor without using a permanent magnet is desirable.

The present invention has been made in view of the above problem, and an object of the present invention is to enable detection of the rotational position of a rotor relative to a stator, using a position sensor in which no permanent magnet is used. An object of a motor according to the present invention is to exploit the advantage of being magnet-less by detecting a rotational position by means of a position sensor in which no permanent magnet is used. The above objects are not limited, and another object of the present invention is to provide operations or effects which are derived by the configurations illustrated the embodiments described below, and which are not obtained with conventional technologies.

(1) A position sensor according to the present disclosure includes a stator formed in a tubular shape, disposed concentrically with a center of rotation of a rotating shaft, and including a plurality of sets of magnetic pole pairs, each of the magnetic pole pairs having a pair of magnetic poles opposing each other and protruding from an inner peripheral surface toward the center of rotation; a rotor fixed to the shaft and having at least a pair of protruding poles protruding radially outward from a reference cylindrical surface at a constant distance from the center of rotation; an excitation circuit including coil pairs which are connected to a direct-current power supply and which include coils wound on the magnetic poles of each of the magnetic pole pairs of each set, the excitation circuit having a switch for switching the on/off of current to each of the coil pairs; and a processing unit for switching the switch and detecting a rotational position of the rotor based on a magnitude relationship of the inductance between the coil pairs of the plurality of sets.

(2) Preferably, the excitation circuit may include a resistor connected in series with the coil pair of each set, and the processing unit may acquire a voltage value across the resistor instead of the inductance.

(3) Preferably, the excitation circuit may include one of the switches connected in series with the direct-current power supply.

(4) Preferably, where N is a natural number, the stator may include 2N sets of the magnetic pole pairs circumferentially displaced from each other by 360/4N degrees, the excitation circuit may include 2N sets of the coil pairs, and the processing unit may compare the magnitudes of the inductance of 2N sets of the coil pairs and output an output signal corresponding to the magnitude relationship.

(5) Preferably, N is a natural number of 2 or more, the magnitudes of the inductance of two sets each of the coil pairs displaced from each other by 360/2N degrees may be compared, and the rotational position and the rotational direction of a rotor may be detected based on a combination of the magnitude relationships.

(6) Preferably, the rotor may be formed from a magnetic material other than permanent magnet.

(7) A motor according to the present disclosure includes the position sensor according to any one of (1) to (6); a motor rotor integrally rotating with the shaft and not including a permanent magnet; and a motor stator fixed to a housing and not including a permanent magnet.

(8) Preferably, a switching frequency of the switch may be determined, based on an upper limit value of an operating rotational speed of the motor, and an electric angle per a mechanical angle 360° of the motor, to be not less than (rotational speed upper limit value/60)×(electric angle/360)×5.

According to the position sensor of the present disclosure, by comparing the magnitudes of the inductance of a plurality of sets of coil pairs, it becomes possible to detect the rotational position of the rotor relative to the stator using a rotor having no permanent magnet. Further, with the position sensor of the present disclosure, the rotational position of the rotor can be detected by phase comparison, so that detection accuracy can be maintained even if the source power supply voltage for the position sensor is varied.

In addition, the motor of the present disclosure detects the rotational position using a position sensor in which no permanent magnet is used, whereby the advantages of being magnet-less can be exploited.

### BRIEF DESCRIPTION OF THE DRAWINGS

FIG. 1 is a schematic diagram of a magnetic circuit portion of a position sensor according to an embodiment, as viewed from an axial direction;

FIG. 2 is a diagram illustrating an electric circuit portion of the position sensor illustrated in FIG. 1;

FIG. 3 is a diagram illustrating an inductance that varies due to rotation of a rotor, a shunt voltage that varies due to switching, and the contents of signal processing performed in a processing unit, in a mechanical angle range of 90 degrees;

FIG. 4 is a schematic exploded perspective view of a motor according to an embodiment;

FIG. 5 is a schematic diagram of a magnetic circuit portion of a position sensor according to a first modification, as viewed from an axial direction;

FIG. 6 is a schematic diagram of a magnetic circuit portion of a position sensor according to a second modification, as viewed from an axial direction; and

FIG. 7 is a diagram illustrating an electric circuit portion of the position sensor illustrated in FIG. 6.

### DESCRIPTION OF THE EMBODIMENTS

With reference to the drawings, a position sensor and a motor according to embodiments will be described. The embodiments which will be described below are merely exemplary, and are not intended to exclude the application of various modifications or techniques not explicitly described in the embodiments. The various configurations of the embodiments may be implemented with modifications without departing from the scope and spirit of the embodiments. Various configurations may be optionally selected or combined, as appropriate.

### 1. Configuration

FIG. 1 is a schematic diagram of a position sensor 1 according to an embodiment, as viewed from an axial direction (axial view) of a shaft 5 (rotating shaft). In the present embodiment, the position sensor 1 does not include a permanent magnet. The rotational position of a rotor 2 (hereafter referred to as “rotor position”) relative to a stator 3 is detected from a variation in an inductance L due to the rotation of the rotor 2, which is fixed to the shaft 5.

In the present embodiment, the position sensor 1 outputs two pulses for each rotation of the rotor 2 (i.e., during the mechanical angle of 360 degrees). That is, in the present embodiment, the position sensor 1 detects (identifies) whether, among the ranges at 90-degrees intervals obtained by dividing the 360-degrees mechanical angle into four equal parts (such as the four ranges of 0 to 90 degrees; 90 to 180 degrees; 180 to 270 degrees; and 270 to 360 degrees), the rotor position is in the first and third ranges (0 to 90 degrees and 180 to 270 degrees) or in the second and fourth ranges (90 to 180 degrees and 270 to 360 degrees). It is to be noted, however, that the number of pulses per rotation of the rotor 2 is not limited to two. Relevant modifications will be described later.

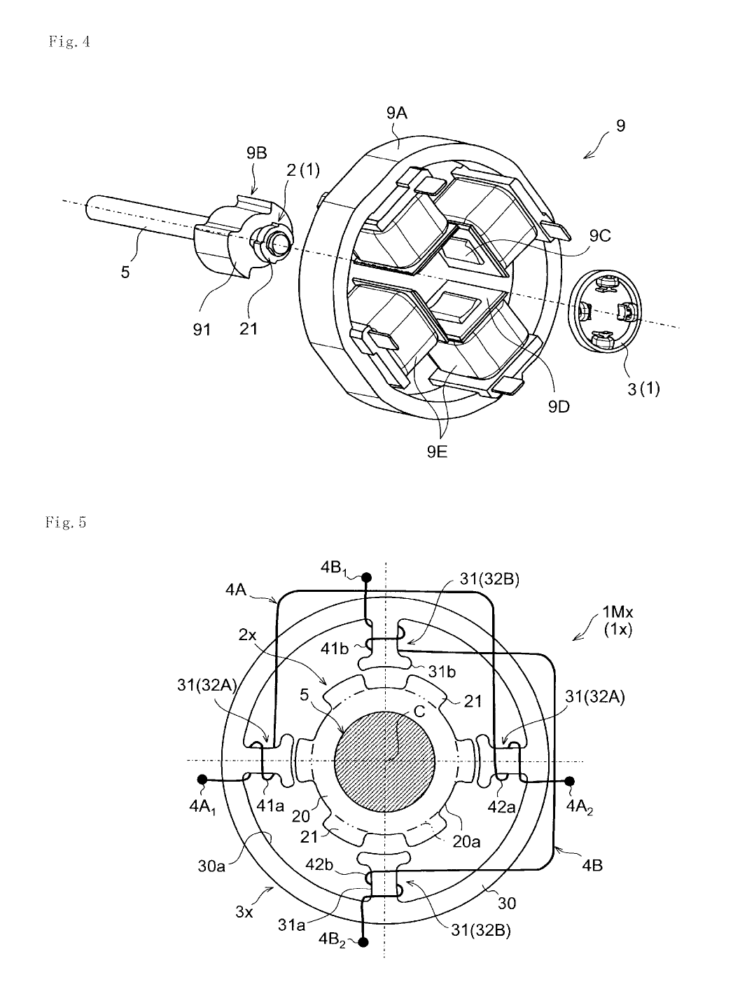

The position sensor 1 is incorporated into a motor 9 illustrated in FIG. 4, for example. The motor 9 is a switched reluctance motor (“SR motor 9”) that does not include a permanent magnet. The motor 9 includes a motor stator 9A fixed to a housing, which is not illustrated, and a motor rotor 9B which rotates integrally with the shaft 5. In FIG. 4, the rotor 2 and the stator 3 of the position sensor 1 are illustrated in an exploded view, and the motor stator 9A and the motor rotor 9B of the SR motor 9 are also illustrated in an exploded view. The motor stator 9A has four motor teeth portions 9C. On each of the motor teeth portions 9C, a motor coil 9E is wound via an insulator 9D.

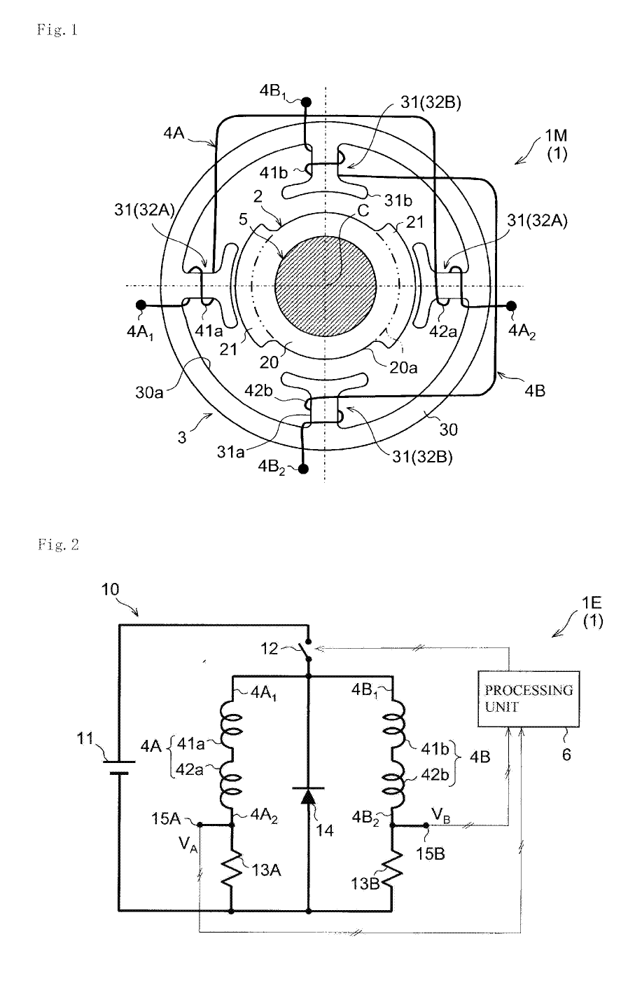

The position sensor 1 is disposed on the shaft 5 of the SR motor 9. The stator 3 is fixed to the housing, and the rotor 2 is fixed to the shaft 5. The position sensor 1 includes a magnetic circuit portion 1M illustrated in FIG. 1, and an electric circuit portion 1E illustrated in FIG. 2. The position sensor 1 detects the rotational position (motor rotation angle) of the SR motor 9 by detecting the rotor position. The magnetic circuit portion 1M includes the rotor 2, the stator 3, and two sets of coil pairs 4A, 4B. The electric circuit portion 1E includes a processing unit 6 and an excitation circuit 10. As will be described later, the coil pairs 4A, 4B are elements that are also included in the excitation circuit 10. In the present embodiment, the rotor 2 is formed from a magnetic material other than permanent magnet (for example, from ferromagnetic and soft magnetic material, such as ferrosilicon or soft ferrite). The magnetic material may be ferromagnetic and soft magnetic.

As illustrated in FIG. 1, the rotor 2 includes a cylindrical portion 20 with a constant distance from the center of rotation C of the shaft 5, and a pair of protruding poles 21 protruding radially outward from a reference cylindrical surface 20a of the cylindrical portion 20. The pair of protruding poles 21 has an identical shape, and is circumferentially displaced from each other by 180 degrees. In the present embodiment, the protruding poles 21 have an arc-shape along the reference cylindrical surface 20a in an axial view. The protruding poles 21 have corner portions at the circumferential ends thereof. The shape of the protruding poles 21 is not limited to the shape illustrated in FIG. 1. In the SR motor 9 of the present embodiment, as illustrated in FIG. 4, the rotor 2 and the motor rotor 9B are fixed to the same shaft 5, and are disposed such that the protruding poles 21 of the rotor 2 and protruding poles 91 of the motor rotor 9B are rotated while maintaining a phase difference.

As illustrated in FIG. 1, the stator 3 is formed in an annular (tubular) shape, and is disposed concentrically with the center of rotation C of the shaft 5. In the present embodiment, the stator 3 includes a tube portion 30 and a plurality of sets of magnetic pole pairs 32. The tube portion 30 is ring-shaped in an axial view. Each of the magnetic pole pairs 32 comprises a pair of magnetic poles 31 which protrude from an inner peripheral surface 30a of the tube portion 30 toward the center of rotation C (i.e., radially inward), and which are opposed to each other. In the present embodiment, by way of example, the stator 3 has two sets of magnetic pole pairs 32 which are circumferentially displaced from each other by 90 degrees. In the following, one of the two sets of magnetic pole pairs 32 will be referred to as a first magnetic pole pair 32A, and the other as a second magnetic pole pair 32B. All of the four magnetic poles 31 are formed in an identical shape.

In the present embodiment, the two sets of magnetic pole pairs 32A, 32B are disposed 90 degrees out of phase from each other. That is, the stator 3 has the four magnetic poles 31 of an identical shape circumferentially displaced from each other by 90 degrees (i.e., at regular intervals). Each of the magnetic poles 31 includes a tooth 31a radially extending from the inner peripheral surface 30a of the stator 3, and a wall portion (hereafter referred to as “fin 31b”) provided at the radially inner end of the tooth 31a, and extending in a fin-shape. Thus, the magnetic poles 31 are substantially T-shaped in an axial view. The surface of the teeth and the coil pairs 4A, 4B are electrically insulated from each other by means of an insulator (not illustrated).

The two sets of coil pairs 4A, 4B are input coils to which current is applied, and which comprise coils wound in opposite directions on the opposing magnetic poles 31 of the respective magnetic pole pairs 32A, 32B. Specifically, the first coil pair 4A (which may be hereafter referred to as “first coil pair 4A”) comprises a coil 41a wound on one magnetic pole 31 of the first magnetic pole pair 32A, and a coil 42a wound on the other magnetic pole 31. Similarly, the second coil pair 4B (which may be hereafter referred to as “second coil pair 4B”) comprises a coil 41b wound on one magnetic pole 31 of the second magnetic pole pair 32B, and a coil 42b wound on the other magnetic pole 31. The coils 41a, 42a are wound such that they provide mutually opposite magnetic poles when energized. When wound continuously in a series connection, as illustrated in FIG. 1, the coils 41a, 42a have mutually opposite winding directions when the magnetic poles 31 are viewed from the center of rotation C. Likewise, the coils 41b, 42b have mutually opposite winding directions. The winding directions of the adjacent coils 41a and 41b may be the same or opposite from each other. All of the coils 41a, 42a, 41b, 42b have the same number of turns.

As illustrated in FIG. 2, in the present embodiment, the excitation circuit 10 includes: a direct-current power supply 11; a switch 12; the two sets of coil pairs 4A, 4B; two resistors 13A, 13B; a diode 14; and two output terminals 15A, 15B. The switch 12 turns on or off the supply of current to the coil pairs 4A, 4B. The switch 12 is connected in series with the direct-current power supply 11. The two sets of coil pairs 4A, 4B are connected in parallel with each other, and are each connected in series with the direct-current power supply 11. The two resistors 13A, 13B are respectively connected in series with the coil pairs 4A, 4B. The diode 14 is connected in series with the direct-current power supply 11. The two output terminals 15A, 15B are respectively provided between the coil pairs 4A, 4B and the resistors 13A, 13B. In the following, when the two output terminals 15A, 15B are distinguished, one on the first coil pair 4A side will be referred to as a first output terminal 15A, and the other on the second coil pair 4B side will be referred to as a second output terminal 15B.

More specifically, one end 4A₁ of the first coil pair 4A is connected to the plus terminal of the direct-current power supply 11 via the switch 12. The other end 4A₂ of the first coil pair 4A is connected to the minus terminal of the direct-current power supply 11 via the resistor 13A. One end 4B₁ of the second coil pair 4B is connected to the plus terminal of the direct-current power supply 11 via the switch 12. The other end 4B₂ of the second coil pair 4B is connected to the minus terminal of the direct-current power supply 11 via the resistor 13B. When the switch 12 is on, current flows through both of the coil pairs 4A, 4B, and it becomes possible to detect voltage values V_{A}, V_{B} across the resistors 13A, 13B, respectively, at the output terminals 15A, 15B, respectively. In the following, when the two voltage values V_{A}, V_{B} are distinguished, the value on the first output terminal 15A side may be referred to as a first voltage value V_{A}, and the value on the second output terminal 15B side may be referred to as a second voltage value V_{B}.

The processing unit 6 performs a process of switching the switch 12 at high frequency during the rotation of the rotor 2, and detecting the rotor position relative to the stator 3 based on the magnitude relationship of the inductance L of the two sets of coil pairs 4A, 4B. The processing unit 6 comprises a signal processing circuit, for example. The switching frequency is set to be sufficiently high at least relative to the rotational speed of the rotor 2. For example, when the SR motor 9 illustrated in FIG. 4 is rotated at 120000 rpm, since the motor is a 2-pole/4-slot motor, given the frequency 2 kHz of motor rotation and the switching twice per rotation, at least 4 kHz is required. However, five times or more of that switching frequency is desirable in order to ensure a sufficient angular resolution for motor control. Accordingly, it is desirable that the switching frequency be 20 kHz or more. In the present embodiment, 50 kHz is adopted. In the present embodiment, the processing unit 6 acquires the voltage values V_{A}, V_{B} across the resistors 13A, 13B, respectively, from the respective output terminals 15A, 15B, instead of the inductance L of the coil pairs 4A, 4B, and processes and converts the voltage values V_{A}, V_{B} into output signals (pulse signals).

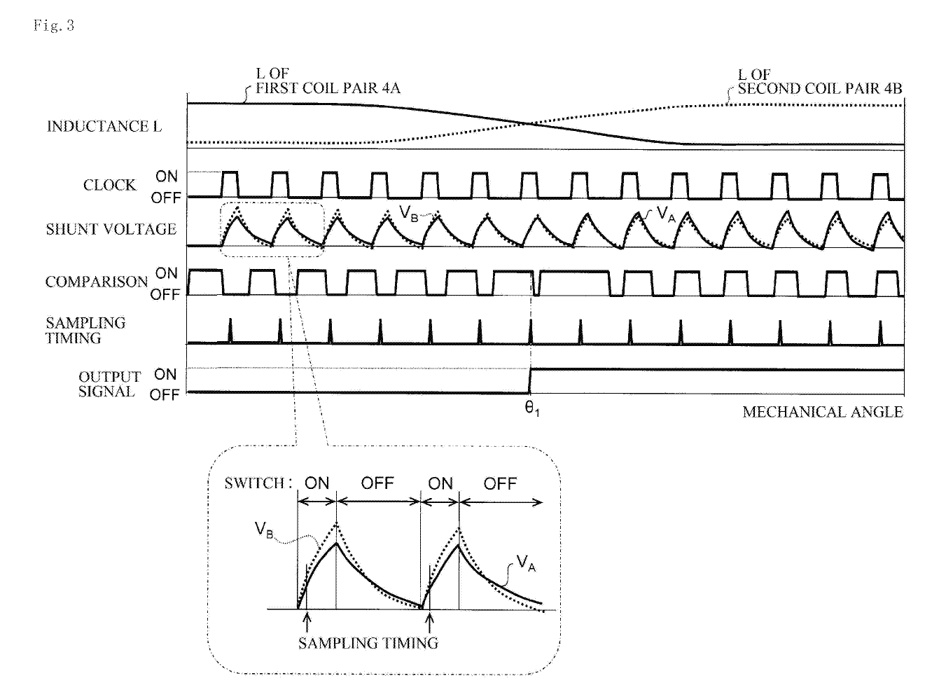

FIG. 3 is a diagram illustrating the inductance L varying due to the rotation of the rotor 2, and the voltage values V_{A}, V_{B} (shunt voltages) varying due to the switching, together with the contents of signal processing performed by the processing unit 6, in a mechanical angle range of 90 degrees. In FIG. 3, the horizontal axis shows the mechanical angle of the rotor 2. FIG. 3 illustrates: the inductance L varying in the mechanical angle range of 90 degrees; a clock (on-off signal) input to the switch 12; the voltage values V_{A}, V_{B} (shunt voltages); the result of comparison of the magnitudes of the two voltage values V_{A}, V_{B}; sampling timing; and output signal. Of the waveforms (voltage waveforms) indicating the variation s in the inductance L and the voltage values V_{A}, V_{B}, the solid lines correspond to the first coil pair 4A and the dashed line corresponds to the second coil pair 4B. In FIG. 3, a part of the voltage waveforms is shown as enlarged by way of example, as indicated by dashed and single-dotted lines.

As the rotor 2 rotates, the distance between the magnetic pole pairs 32A, 32B and the outer peripheral surface of the rotor 2 varies. For example, when the rotor position is in the state illustrated in FIG. 1, the distance between the first magnetic pole pair 32A and the outer peripheral surface of the rotor 2 is smaller than the distance between the second magnetic pole pair 32B and the outer peripheral surface of the rotor 2 by the amount of protrusion of the protruding poles 21. Accordingly, the magnetic resistance of the first coil pair 4A becomes smaller than the magnetic resistance of the second coil pair 4B, and the amount of magnetic flux generated by excitation becomes greater for the first coil pair 4A than for the second coil pair 4B. That is, in the case of the rotor position illustrated in FIG. 1, the inductance L is greater for the first coil pair 4A than for the second coil pair 4B. When the switch 12 is turned on in this state, the current rises more slowly for the first coil pair 4A with the greater inductance L than for the second coil pair 4B.

When the rotor 2 rotates by more than 45 degrees from the state of FIG. 1, the protruding poles 21 are separated from the first magnetic pole pair 32A and become closer to the second magnetic pole pair 32B. As a result, the amount of magnetic flux generated by excitation becomes smaller for the first coil pair 4A than for the second coil pair 4B, and the inductance L becomes smaller for the first coil pair 4A than for the second coil pair 4B. Accordingly, if the switch 12 is turned on in this state, the current rises more quickly for the first coil pair 4A with the smaller inductance L than for the second coil pair 4B.

In other words, the outer peripheral surface of the rotor 2 is closer to the magnetic pole pair 32A or 32B on which, of the two sets of coil pairs 4A, 4B, the one with a smaller current value is wound. Accordingly, by repeating the turning on/off of the switch 12 at high speed, and comparing the magnitudes of the current values of the two sets of coil pairs 4A, 4B at an arbitrary timing when the switch 12 is on, it becomes possible to determine the position of the protruding poles 21 of the rotor 2 (i.e., rotor position). In the present embodiment, the excitation circuit 10 outputs the voltage values V_{A}, V_{B}, indicated by solid lines and dashed lines in FIG. 3, respectively across the resistors 13A, 13B from the respective output terminals 15A, 15B, instead of current values. Accordingly, the processing unit 6 compares the magnitudes of the voltage values V_{A}, V_{B}.

The inductance L, as indicated by solid line and dashed line in FIG. 3, has the characteristics such that when the inductance L of one is large, the inductance L of the other is small; as the inductance L of the one begins to decrease, the inductance L of the other begins to increase, and the magnitude relationship are reversed at a certain angle. The position (mechanical angle) at which the magnitude relationship of the inductance L are reversed is the position rotated by 45 degrees from the rotor position of FIG. 1; that is, the mechanical angle at which the protruding poles 21 are positioned at the center of two circumferentially adjacent magnetic poles 31. The processing unit 6 detects (identifies) the rotor position by converting the voltage waveforms into output signals through the process described above, instead of directly detecting a variation (characteristic) in the inductance L.

As illustrated in FIG. 3, the processing unit 6 inputs to the switch 12 a clock signal repeating on and off states at predetermined cycles (such as 50 kHz). That is, when the clock is on, the switch 12 turns on, current flows through the coil pairs 4A, 4B and voltages are output from the output terminals 15A, 15B. In this case, the rise of the voltage (current) is determined by the inductance L of the coil pairs 4A, 4B. For example, when the inductance L of the first coil pair 4A is greater, the rise of the voltage when the clock (switch 12) is on is quicker for the second voltage value V_{B} than for the first voltage value V_{A} (i.e., the second voltage value V_{B} has a steeper slope), as shown enlarged in the figure.

The processing unit 6 acquires the comparison waveforms (on/off signals for comparison) illustrated in FIG. 3 by inputting the two voltage values V_{A}, V_{B} to a comparator (not illustrated). In the present embodiment, the comparator outputs an on-signal when the first voltage value V_{A}≥the second voltage value V_{B}, and outputs an off-signal when the first voltage value V_{A}<the second voltage value V_{B}. Alternatively, the comparator may be configured to output an off-signal when the first voltage value V_{A}≥the second voltage value V_{B}, and to output an on-signal when the first voltage value V_{A}<the second voltage value V_{B}. The sampling timing is a signal for determining the timing of extraction of the on/off signals for comparison, and is synchronized with the clock. The sampling timing may be aligned with the instant of switching of the clock from off to on, or from on to off, for example. Alternatively, the sampling timing may be an arbitrary timing, such as several microseconds after the instant of switching.

The processing unit 6 extracts the on/off signals for comparison at the sampling timing synchronized with the clock, and outputs output signals of the same on-off states as the on-signal and off-signal for comparison. That is, the processing unit 6 outputs an on-output signal when the comparison is on-signal, and outputs an off-output signal when the comparison is off-signal. In the example illustrated in FIG. 3, the output signal switches from off to on at the mechanical angle θ₁ when the two voltage waveforms are substantially overlapping. The switch timing (i.e., the mechanical angle θ₁) is an angle at which the magnitude relationship of the inductance L is reversed, and which, in the present embodiment, is a position rotated from the rotor position of FIG. 1 by 45 degrees. While FIG. 3 only illustrates the mechanical angle range of 90 degrees, output signals similar to those of FIG. 3 are output in each of the ranges of 90 to 180 degrees, 180 to 270 degrees, and 270 to 360 degrees. Thus, even when the inductance L cannot be directly detected, the magnitude relationship of the inductance L can be determined from voltage waveforms, making it possible to detect (identify) the rotor position.

The rotor 2 of the position sensor 1 and the motor rotor 9B of the SR motor 9 are both fixed to the shaft 5 in a non-rotatable manner. Accordingly, the rotor position can be detected (identified) based on the output signal (on or off) output from the processing unit 6. It further becomes possible to implement current control to cause the motor rotor 9B to rotate based on the output signal (or rotor position information).

### 2. Effects

(1) In the position sensor 1, the inductance L of the coil pairs 4A, 4B varies depending on the rotational position of the rotor 2 having the pair of protruding poles 21, and the rotor position is detected by utilizing the difference in the rise of currents in the coil pairs 4A, 4B due to the variation in the inductance L. That is, with the position sensor 1, by comparing the magnitudes of the inductance of the coil pairs 4A, 4B, it becomes possible to detect the rotor position relative to the stator 3 using the rotor 2 having no permanent magnet.

In addition, with the position sensor 1, the rotor position can be detected by phase comparison. Accordingly, even when the voltage of the direct-current power supply 11 is varied, for example, detection accuracy can be maintained. Further, with the position sensor 1, the configuration of the magnetic circuit portion 1M and the configuration of the electric circuit portion 1E can be simplified.

(2) In the position sensor 1, the excitation circuit 10 is provided with the resistors 13A, 13B, and the processing unit 6 acquires the voltage values V_{A}, V_{B} output from the output terminals 15A, 15B, instead of current. That is, the magnitudes of voltage values are compared instead of currents, so that the rotor position can be detected easily.

(3) In the excitation circuit 10, the switch 12 is connected in series, rather than in parallel, with the direct-current power supply 11. Accordingly, the current that flows through the coil pairs 4A, 4B as a whole can be switched at one location, whereby the configuration can be simplified.

(4) In the position sensor 1, the stator 3 has the two sets of magnetic pole pairs 32A, 32B, and the processing unit 6 outputs an on-signal (output signal) when the current through one of the two sets of coil pairs 4A, 4B (in the present embodiment, voltage value V_{A}) is not less than the current through the other (voltage value V_{B}). Accordingly, the rotor position can be detected in a simple configuration. In addition, the position sensor 1 outputs two pulses per rotation, so that the rotational speed of the SR motor 9 can also be detected by counting the number of pulses.

(5) When the rotor 2 is formed from a magnetic material other than permanent magnet, as in the position sensor 1, inexpensive and relatively easy-to-process material, such as ferrosilicon, can be used, whereby the cost of the rotor 2 can be reduced.

(6) The position sensor 1 does not use permanent magnet. Accordingly, by detecting the rotational position using the position sensor 1, the advantages of the SR motor 9, such as high robustness and heat resistance, can be exploited. In addition, with the SR motor 9, the position sensor 1 can maintain detection accuracy regardless of any voltage variation in the direct-current power supply 11, as described above. Accordingly, stable current control for rotating the motor rotor 9B can be implemented.

### 3. Others

While the embodiment has been described with reference to the example in which the position sensor 1 outputs two pulses per rotation, the configuration of the position sensor 1 is not limited to the example. In another example, as illustrated in FIG. 5, a position sensor 1x may be provided with a rotor 2x having three sets of a pair of protruding poles 21. The position sensor 1x (magnetic circuit portion 1Mx) of FIG. 5 differs from the position sensor 1 of the foregoing embodiment in the shape of the rotor 2x and the length of fins 31b of a stator 3x in the rotational direction. The position sensor 1x is identical to the position sensor 1 in other configurations (such as the configuration of the excitation circuit 10, and the contents of processing in the processing unit 6).

In the position sensor 1x, the six protruding poles 21 of an identical shape are displaced from each other by 60 degrees in the circumferential direction of the rotor 2x. The fins 31b of the magnetic poles 31 of the stator 3x have a rotational direction length which is approximately the same as a rotational direction length of the protruding poles 21 of the rotor 2x. When the rotational direction length of the fins 31b is increased, the variation of the inductance L is decreased. Accordingly, it may be desirable that the fins 31b and the protruding poles 21 have a length relationship such that, when the central position of one of the fins 31b and the central position of one of the protruding poles 21 are aligned, the ends in the rotational direction of the fin 31b are not greater than one-fourth the recess between the protruding poles 21b.

With the position sensor 1x, the magnitude relationship of the inductance L of the two sets of coil pairs 4A, 4B are reversed at cycles (mechanical angle) shorter than those in the foregoing embodiment. Because the position sensor 1x outputs six pulses per rotation, it is possible to identify the rotor position at 30-degrees intervals corresponding to 12 equal parts of the 360-degrees mechanical angle. Thus, with the position sensor 1x according to the present modification, it is possible to obtain similar effects from a configuration similar to that of the foregoing embodiment. Further, with the position sensor 1x where the number of protruding poles of the rotor 2x is increased, it is possible to control a motor in which the rotor position needs to be identified at finer angular intervals.

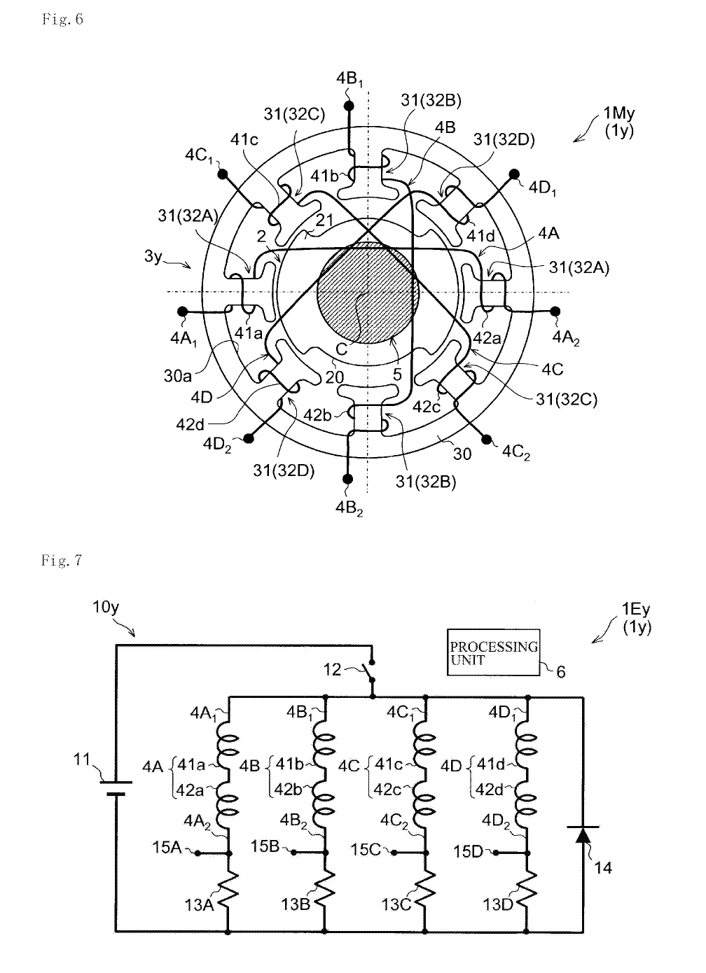

In the foregoing embodiment, the stator 3 of the position sensor 1 has the two sets of magnetic pole pairs 32A, 32B. However, the number of sets of the magnetic pole pairs is not limited to the embodiment. For example, when N is a natural number, the position sensor may be provided with a stator having 2N sets of magnetic pole pairs circumferentially displaced from each other by 360/4N degrees. In this case, 2N sets of the coil pair are provided in the excitation circuit. The processing unit compares the magnitudes of the inductance of the sets of coil pairs and outputs output signals corresponding to the magnitude relationship. In the case of the stator 3 of the foregoing embodiment, N=1. FIG. 6 illustrates a stator 3y by way of example in which N=2.

As illustrated in FIG. 6, a position sensor 1y (magnetic circuit portion 1My) is provided with the stator 3y, which includes four sets of magnetic pole pairs 32 each comprising a pair of magnetic poles 31. Specifically, the stator 3y includes four sets of magnetic pole pairs 32A, 32B, 32C, 32D circumferentially displaced from each other by 45 degrees. The position sensor 1y is provided with four sets of coil pairs 4A, 4B, 4C, 4D. As in the foregoing embodiment, the coil pairs 4A to 4D respectively comprise coils 41a and 42a, coils 41b and 42b, coils 41c and 42c, and coils 41d and 42d that are wound on the respective magnetic poles 31 of the magnetic pole pair 32A to 32D. The position sensor 1y of FIG. 6 is provided with the same rotor 2 as in the foregoing embodiment.

FIG. 7 illustrates an example of an electric circuit portion 1Ey of the position sensor 1y of FIG. 6. In FIG. 7, signal lines are omitted. The processing unit 6 compares the magnitudes of the inductance L of two sets for each of coil pairs that are displaced from each other by 90 degrees among the four sets of coil pairs 4A to 4D. The processing unit 6 then outputs output signals corresponding to the magnitude relationship, and detects (identifies) the rotor position and rotational direction of the rotor 2 based on two output signals. In the present modification, too, resistor 13A to 13D are respectively connected in series with the coil pairs 4A to 4D, as illustrated in FIG. 7, and voltage values output from respective output terminal 15A to 15D are acquired, instead of the inductance L.

Specifically, the processing unit 6 compares the magnitudes of the inductance L (or voltage values) of two sets of coil pairs 4A, 4B, and compares the magnitudes of the inductance L (or voltage values) of two sets of coil pairs 4C, 4D. Then, the processing unit 6 outputs two output signals corresponding to the respective magnitude relationships. For example, when the inductance L of coil pair 4A≥the inductance L of coil pair 4B, the processing unit 6 outputs “a first output signal=on”; when the inductance L of coil pair 4A<the inductance L of coil pair 4B, the processing unit 6 outputs “the first output signal=off”. Further, when, for example, the inductance L of coil pair 4C≥the inductance L of coil pair 4D, the processing unit 6 outputs “a second output signal=on”; when the inductance L of coil pair 4C<the inductance L of coil pair 4D, the processing unit 6 outputs “the second output signal=off”.

In the present modification, the processing unit 6 detects the rotor position based on the on-off states of the first output signal and the second output signal. With the position sensor 1y of the present modification, it is also possible to detect the rotational direction of the rotor 2 because the first output signal and the second output signal have different phases. That is, when N is a natural number of 2 or more, with a position sensor having two sets for each of coil pairs displaced from each other by 360/2N degrees, as in the case of the position sensor 1y of the present modification, it is possible to compare the magnitudes of the inductance L of two sets for each of coil pairs, and to detect the rotor position and the rotational direction of a rotor based on a combination of the magnitude relationships.

In the foregoing embodiment, the processing unit 6 implements both the switching of the switch 12 and the signal processing based on the output voltage values. However, this is by way of example, and the functions (switching and signal processing) of the processing unit 6 may be divided into two elements. In addition, the switching frequency of the switch 12 is not limited to 50 kHz. Preferably, based on the upper limit value (upper limit rotational speed) of the operating rotational speed of the motor and an electric angle per the mechanical angle 360° of the motor, the switching frequency may be set such that “switching frequency≥(upper limit rotational speed/60)×(electric angle/360)×5”.

The configurations of the excitation circuits 10, 10y described above are merely examples and are not intended to be limited. For example, a current value may be detected by omitting the resistor 13A and the like, or there may be more than one switch 12. While in FIG. 1 and FIG. 2, the coil 41a and the coil 42a, and the coil 41b and the coil 42b are respectively connected in series, they may be connected in parallel. When in a parallel configuration, the absolute values of the inductance L of the coil pairs 4A, 4B may be changed and the current that flows through each phase may increase. However, the magnitude relationship of the inductance L between the coil pairs 4A, 4B will not change, and the same outputs are obtained as in the case of the series connection. This relationship is also the same in the case of FIG. 6 and FIG. 7.

The shapes of the rotors 2, 2x and the stators 3, 3y in the foregoing embodiment and the modifications are merely examples and are not intended to be limited. The rotor may have at least a pair of protruding poles protruding radially outward from the reference cylindrical surface at a constant distance from the center of rotation, and may have an elliptical shape, for example. The outer shape of the stator in an axial view may not be a ring-shape but may be a shape having a corner portion (such as a rectangle or an octagon). The position sensors 1, 1x, 1y may not be dedicated for the SR motor 9 and may be provided in a motor other than the SR motor 9, such as a brushless motor, or in a generator, for example.

What is claimed is:

1. A position sensor comprising:
a stator formed in a tubular shape, disposed concentrically with a center of rotation of a rotating shaft, and including a plurality of sets of magnetic pole pairs, each of the magnetic pole pairs comprising a pair of magnetic poles opposing each other and protruding from an inner peripheral surface toward the center of rotation;
a rotor fixed to the shaft and having at least a pair of protruding poles protruding radially outward from a reference cylindrical surface at a constant distance from the center of rotation;
an excitation circuit including coil pairs which are connected to a direct-current power supply and which include coils wound on the magnetic poles of each of the magnetic pole pairs of each set, the excitation circuit having a switch for switching the on/off of currents to each of the coil pairs; and
a processing unit for switching the switch and detecting a rotational position of the rotor based on a magnitude relationship of an inductance between the coil pairs of the plurality of sets.

2. The position sensor according to claim 1, wherein:
the excitation circuit includes a resistor connected in series with the coil pair of each set; and
the processing unit acquires a voltage value across the resistor instead of the inductance.

3. The position sensor according to claim 1, wherein the switch of the excitation circuit is connected in series with the direct-current power supply.

4. The position sensor according to claim 1, wherein:
where N is a natural number;
the stator includes 2N sets of the magnetic pole pairs circumferentially displaced from each other by 360/4N degrees;
the excitation circuit include 2N sets of the coil pairs;
the processing unit compares the magnitudes of the inductance of two sets of coil pairs and outputs an output signal corresponding to the magnitude relationship.

5. The position sensor according to claim 4, wherein:
N is a natural number of 2 or more;
the magnitude relationships of the inductance of two sets each of the coil pairs displaced from each other by 360/2N degrees are compared, and the rotational position and the rotational direction of the rotor are detected based on a combination of the magnitude relationships.

6. The position sensor according to claim 1, wherein the rotor is formed from a magnetic material other than permanent magnet.

7. A motor comprising:
the position sensor according to claim 1;
a motor rotor integrally rotating with the shaft and not including a permanent magnet; and
a motor stator fixed to a housing and not including a permanent magnet.

8. The motor according to claim 7, wherein a switching frequency of the switch is determined, based on an upper limit value of an operating rotational speed of the motor, and an electric angle per a mechanical angle 360° of the motor, to be not less than (rotational speed upper limit value/60)×(electric angle/360)×5.
